(19) United States
(12) Patent Application Publication
(10) Pub. No.: US 2009/0109453 A1
(43) Pub. Date: Apr. 30, 2009

(54) IMAGE FORMING APPARATUS AND IMAGE FORMING METHOD

(75) Inventor: Nobuhiko Nakahara, Susono-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/877,743

(22) Filed: Oct. 24, 2007

(51) Int. Cl. G06K 1/00; H04N 1/46

(52) U.S. Cl. 358/1.9; 358/534

(57) ABSTRACT

An image forming apparatus includes an electrophotographic printer including a printer controller that performs an image processing on image data into which a page description language is developed and outputs the data to a printer engine, and the printer engine to perform printing of an image based on the image data transmitted from the printer controller, and an image quality maintaining control device to maintain image quality of the printer, and the image quality maintaining control device includes a halftone parameter control unit to change a halftone parameter when an image quality maintaining control processing of the printer is executed. According to the image forming apparatus, an image more stable than the related art can be maintained against an image quality variation caused by a mechanism or a process influenced by aging or environmental variation.

### BACKGROUND OF THE INVENTION

1. Technical Field of the Invention

The present invention relates to an apparatus and a method for performing image formation, which adopts an output equipment of an electrophotographic system, and particularly to an image forming apparatus and an image forming method for maintaining a stable image against image quality variations due to a mechanism or a process.

2. Related Art

An image forming apparatus handling a color image is generally based on CMYK, in which four colors of C (Cyan), M (Magenta), Y (Yellow) and K (Black) are applied, and a formed image is outputted.

In general, with respect to an image to be outputted by a printer, digital data created by various applications are transferred to a controller through a printer driver, and are accurately rasterized by the controller. The controller handles complicated and various objects, and various rasterized images are subjected to various image processings such as color conversion and halftone processing, and the images are accurately reproduced by a print engine.

In the various image processings, since a large influence is exerted on image quality dependent on a device such as an engine, and because of restriction of an image path on a system and other various factors, plural optimum parameters of the image processings are previously prepared by a manufacturer, and the user normally selects a mode suitable for an object of printing from a printer driver, and obtains a print output.

Although an image forming apparatus generally adopts an output equipment of an electrophotographic system, this electrophotographic device has a very complicated structure, the change of material characteristics of a toner, a developer and the like are liable to occur due to an environmental variation by temperature/humidity and aging, wear-out of a mechanism and the like, and there can occur a case where the characteristic of an outputted image is remarkably changed.

In order to provide a stable output image to a user against such variation, in general, an engine correction mechanism as image quality maintaining control means is made to function, and the variation in the inside of the engine is stabilized. As parameters for the image quality maintenance, in addition to analog adjustments such as, based on outputs of various sensors, a T/C adjustment of a developer (toner concentration adjustment), an adjustment of various potentials of a process, and an adjustment of laser power, there are known digital adjustments such as a TRC correction to stabilize the tone characteristic of a halftone of an image.

As a well-known example relating to such an invention, there is, for example, JP-A-5-328131 or JP-A-4-239270.

However, in the related art apparatus and method, it is difficult to completely stabilize the image quality, and in order to realize the maintenance of high image quality, because of a high power laser, an expensive material, a high-precision mechanical mechanism and the like, there is a problem that the manufacturing cost is remarkably increased.

Besides, in the TRC correction by an image processing, in the case where a macroscopic area is seen, the characteristic of a halftone can be matched to a target characteristic, however, essentially, with respect to the stability in the case where a microscopic area is seen, there has been a problem that toner is scattered and a granular property is deteriorated, or thin line reproduction becomes unstable.

Thus, it is desired to provide an image forming apparatus and an image forming method in which a stable image can always be maintained also against an image quality variation caused by a mechanism or a process influenced by aging or environment variation.

### SUMMARY OF THE INVENTION

The present invention has been made in view of the above circumstances, and has an object to provide an image forming apparatus and an image forming method in which an image more stable than the related art can be maintained against a variation of image quality caused by a mechanism or a process influenced by aging or environmental variation.

According to an aspect of the invention, in order to solve the problem, an image forming apparatus includes an electrophotographic printer including a printer controller that performs an image processing on image data into which a page description language is developed and outputs the image data to a printer engine, and the printer engine to perform printing of an image based on the image data transmitted from the printer controller, and an image quality maintaining control device configured to maintain image quality of the printer, and the image quality maintaining control device includes a halftone parameter control unit configured to change a halftone parameter when an image quality maintaining control processing of the printer is executed.

According to another aspect of the invention, in order to solve the problem, in an image forming method, when an image quality maintaining control processing of an electrophotographic printer is executed, a halftone parameter control processing of changing a halftone parameter is executed. Here, as examples of the image quality maintaining control processing, there are a process potential adjustment, a laser power adjustment, a development density adjustment, and a tone correction by an image processing. Besides, the halftone parameter control processing is a processing of switching screen data of the halftone processing, and is executed, for example, in the case where the output amount of the printer reaches a specified amount, in the case where a physical quantity acquired by a sensor device and a condition derived based on the physical quantity deviate from a specified range, in the case where a consumable part is replaced, in the case where it is detected that a sheet as a print object is a specific sheet, and in the case where a forcible change request is received.

Accordingly, according to the image forming apparatus and the image forming method of the invention, when the image quality maintaining control processing of the electrophotographic printer is executed, the halftone parameter control processing of changing the halftone parameter is also executed, and therefore, it is possible to maintain an image more stable than the related art against the change of image quality caused by a mechanism or a process influenced by aging or environmental change.

### BRIEF DESCRIPTION OF THE DRAWINGS

In the accompanying drawings:

FIG. 1 is a view illustrating an application example of an image forming apparatus of the invention;

FIG. 2 is a view schematically illustrating a structure of the image forming apparatus of the invention;

FIG. 3 is a view relating to image quality maintenance of an image forming apparatus of the invention and illustrating the outline for matching a tone characteristic to a target by image quality maintaining control;

FIG. 4A is a view illustrating an example of a method of adjusting a halftone parameter by adjustment of the number of screen lines and is a view illustrating an output pattern after a halftone processing of a certain color (for example, black) of four colors of CMYK;

FIG. 4B is a view illustrating an output pattern corresponding to FIG. 4A and is a view illustrating the output pattern after the halftone parameter adjustment;

FIG. 5A is a view illustrating an example of a method of adjusting a halftone parameter by adjustment of a dot interval and size and is a view illustrating an output pattern after a halftone processing of a certain color (for example, black) of four colors of CMYK;

FIG. 5B is a view illustrating an output pattern corresponding to FIG. 5A and is a view illustrating the output pattern after the halftone parameter adjustment;

FIG. 6A is a view illustrating an example of a method of adjusting a halftone parameter by adjustment of a shape and angle and is a view illustrating an output pattern after a halftone processing of a certain color (for example, black) of four colors of CMYK; and

FIG. 6B is a view illustrating an output pattern corresponding to FIG. 6A and is a view illustrating the output pattern after the halftone parameter adjustment.

### DETAILED DESCRIPTION OF THE PREFERRED EMBODIMENTS

Embodiments of an image forming apparatus of the invention will be described with reference to the accompanying drawings.

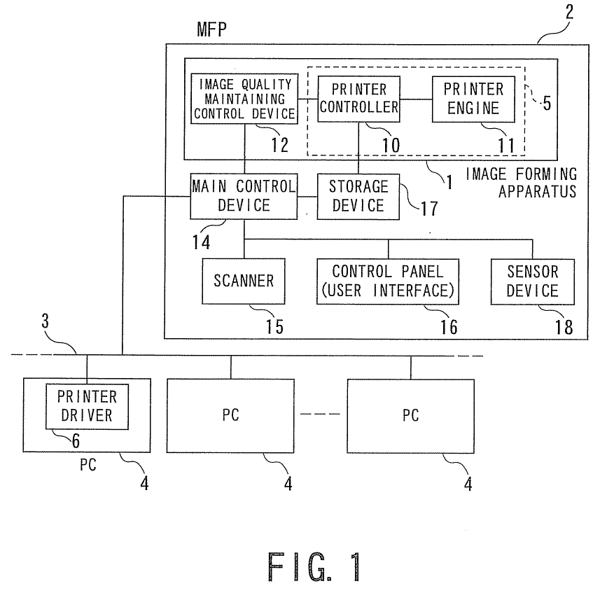

FIG. 1 is a view illustrating an application example of an image forming apparatus 1 as an example of the image forming apparatus of the invention.

As shown in FIG. 1, the image forming apparatus 1 is, for example, an apparatus to realize one function of many functions of an MFP 2 (Multi Function Peripherals), and is mutually connected to, for example, an arbitrary computer terminal (hereinafter, abbreviated as PC) 4 through a network 3. The image forming apparatus 1 receives PDL data indicating a structure of image data from the PC 4. That is, the PC 4 transmits a PDL code or PDL data represented in raster from a printer driver 6 of the PC 4 to a printer 5 in accordance with an interface characteristic to the printer 5 incorporated as a partial function of the image forming apparatus 1.

The printer 5 is an output equipment (electrophotographic device) of an electrophotographic system, and includes a printer controller 10 and a printer engine 11. The printer engine 11 is driven and controlled by the printer controller 10.

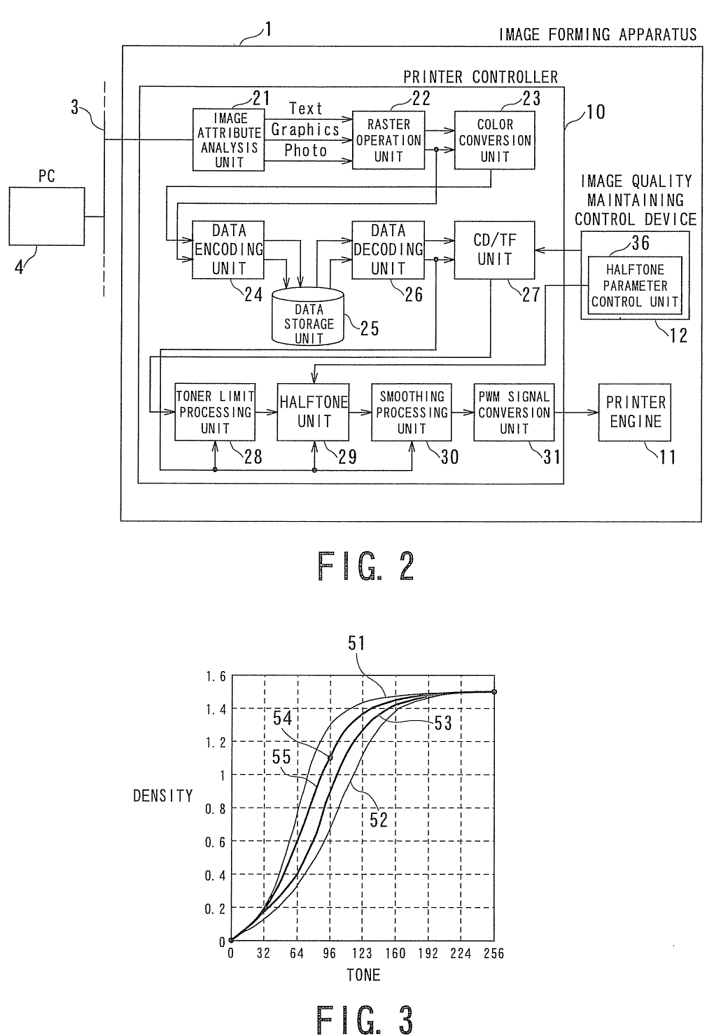

The printer controller 10 has an RIP function, and performs an RIP processing of developing a page description language of the PDL data transmitted from the PC 4 into a bitmap, and after various image processings are performed, image data is stored in a data storage unit 25 (omitted in FIG. 1 and shown in FIG. 2 described later) such as a built-in memory. Besides, the printer controller 10 transmits the image data as a print object to the printer engine 11 when printing is performed.

The printer engine 11 converts the image data of the bitmap from the printer controller 10 into a drive signal, and carries out a printing operation by performing the transport of a sheet, the drive control of a laser and the like. Besides, the improvement of the performance of the RIP function in the recent printer controller 10 is remarkable, and there is also a case where the attribute of each object is analyzed, image processing optimum for each is performed, and composition and output can be performed.

Here, in FIG. 1, reference numeral 12 denotes an image quality maintaining control device to maintain an image quality by performing a control in which the printer controller 10 and the printer engine 11 operate together, 14 denotes a main control device to manage and control the whole MFP 2, 15 denotes a scanner having a scan function of an image, 16 denotes a control panel as a user interface, 17 denotes a storage device constructed of an information recording medium such as a HDD (Hard Disk Drive) or a memory, and 18 denotes a sensor device having various sensors necessary for realizing image formation, image quality maintaining control and other functions.

Incidentally, it is not always necessary that the PC 4 and the printer 5 are connected through the network, and there is also a case where they are used through USB connection or the like, and there is also a case where they are in one-to-one relation. Besides, an interface of the printer controller 10 and the printer engine 11 basically depends on the architecture of the printer, and is not particularly regulated.

Further, there is also a case where the image quality maintaining control device 12 is constructed as a part of the main control device 14. That is, there is also a case where the main control device 14 is constructed to include the image quality maintaining control device 12.

FIG. 2 is a view for explaining a schematic structure of the image forming apparatus 1 and the outline of an image processing flow executed in the image forming apparatus 1.

The image forming apparatus 1 includes the printer 5 including the printer controller 10 that develops the page description language of data such as the PDL (for example, Postscript or PCL) language transmitted from the PC 4 into image data of, for example, a bitmap or the like, and performs various image processings on the image data, and the printer engine 11 that converts the image data transmitted from the printer controller 10 into the drive signal and carries out the print operation by performing the transport of a sheet, the drive control of a laser and the like, and the image quality maintaining control device 12 that maintains the image quality by performing the control in which the printer controller 10 and the printer engine 11 operate together.

The printer controller 10 includes an image attribute analysis unit 21 to analyze the attribute of an image based on the PDL data and to classify the kinds, a raster operation unit 22 to convert code data included in the PDL data into bitmap data, a color conversion unit 23 to convert a color coordinate system of an image, a data encoding unit 24 to encode received data, a data storage unit 25 to store data, a data decoding unit 26 to decode the encoded data, a CD/TF (Caribration Data/Transfer Function) unit 27 to perform γ conversion on received image data, a toner limit processing unit 28, a halftone unit 29, a smoothing processing unit 30, and a PWM (Pulse Wide Modulation) signal conversion unit 31.

The image attribute analysis unit 21 has a function to analyze the attribute of an image based on the PDL data and to classify the kinds. The image attribute analysis unit 21 receives the PDL data transmitted from the printer driver 6 by a trigger of a print instruction from the PC 4, analyzes the attribute of an image from the received PDL code and classifies the kinds.

In case where a rough classification is made, the attribute of the image is basically an attribute of one of a text, a graphic, and a photo bitmap. With respect to the information of the attribute of the image, the attribute of each type is assigned as a tag. For example, in the case where the three kinds of attributes are included, the tag data of 2 bits is required. The tag data, together with the image data (PDL data), is transmitted to the raster operation unit 22 which is later stage.

The raster operation unit 22 has a function (RIP function) to convert the code data included in the PDL data into bitmap data. When receiving the PDL data, the raster operation unit 22 converts the code data included in the PDL data into the bitmap data. For example, in the case of a color printer, digital data of 8 bits of each color of RGB is converted, and in the case of a monochrome printer, a conversion is made into bitmap data of 8 bits of a monochrome color. At this time, tag data corresponding to that position is also assigned to each bitmap data. That is, the bitmap data includes the tag data in addition to the image data representing the image. The raster operation unit 22 transmits the converted bitmap data to the color conversion unit 23.

The color conversion unit 23 has a function to convert a color coordinate system. Specifically, it has a function to convert the RGB colors, which are standard for a monitor or the like, into CMY colors as color reproduction colors in the printer 5 or CMYK colors. Besides, the color conversion unit 23 has a function to switch the color conversion processing according to the attribute of each image based on the tag data.

When receiving the bitmap data (RGB color signal) of 8 bits of each color converted by the raster operation unit 22, the color conversion unit 23 converts it into the CMY colors as color reproduction colors in the printer 5 or the CMYK colors. At this time, the color conversion unit 23 performs a color conversion processing according to the attribute of each image based on the tag data transmitted from the raster operation unit 22. Here, R, G and B denote respective colors of red, green and blue, and C, M, Y and K denote respective colors of cyan, magenta, yellow and black. The color conversion unit 23 transmits the data of the image, in which the color coordinate system is converted, to the data encoding unit 24.

The data encoding unit 24 has a function to encode the received data and to compress the data. When receiving the color-converted image data, the data encoding unit 24 performs an encoding processing of the data and compresses the data. It is desirable that the compression system at this time is a system of efficiently compressing multi-level image data. However, basically, an irreversible compression system is adopted.

The data storage unit 25 has a function to temporarily store the compressed image data. The compressed image data is temporarily stored in the data storage unit 25, so that the amount of data stored in the storage device 17 can be suppressed, and the performance of the whole system can be improved.

The data decoding unit 26 performs a decoding processing of the received data, and has a function to decompress the compressed data. The data decoding unit 26 reads the encoded image data from the storage device such as, for example, a HDD, and decodes the encoded image data in accordance with a specified procedure. The data decoding unit 26 transmits the decoded image data to the CD/TF unit 27.

The CD/TF unit 27 has a function to execute a characteristic conversion processing, such as, for example, γ conversion (γ correction), necessary for obtaining a desirable nonlinear characteristic on the received image data, and obtains calibration of image density according to the characteristic of the printer engine 11 and a desired tone characteristic. In view of the characteristic of the image of each object, in order to enable the characteristic conversion processing of obtaining the optimum image characteristic to be executed, the CD/TF unit 27 is constructed such that the content of the CD/TF processing is switched (selected) based on the tag data included in the bitmap data and the processing can be carried out.

The toner limit processing unit 28 converts the image data so that the image data falls within a limit range considering the actually printable maximum toner adhesion amount of the CMYK total amount in the printer engine 11. In order to enable the optimum toner limit amount to be selected in view of the characteristic of the image of each object, the toner limit processing unit 28 is constructed so that the optimum toner limit processing is switched (selected) based on the tag data included in the bitmap data and is carried out.

The halftone unit 29 has a function to perform a halftone processing using, for example, a threshold matrix for each color, and uses the function to convert the data of one pixel into image data of a tone number in which each color number bit is smaller according to the printing performance of the printer 5 (halftone processing). In order to enable the optimum halftone processing to be carried out based on the tag data included in the bitmap data in view of the characteristics of images among respective objects, the halftone unit 29 is constructed such that the screen data is switched (selected) and the halftone processing can be carried out.

The smoothing processing unit 30 has a function to perform a smoothing processing such that pseudo high resolution conversion is performed on the image with an actual resolution to smooth the line or to reduce the amount of toner consumption by thinning, and uses the function to execute the smoothing processing. In order to enable the optimum smoothing processing to be carried out based on the tag data included in the bitmap data in view of the characteristics of the images among the respective objects, the smoothing processing unit 30 is constructed such that the smoothing processing is switched (selected) and can be carried out. In the smoothing processing at this time, the algorithm of the processing is determined by, for example, the specifications of the PWM division number and the like of the printer engine 11.

The PWM signal conversion unit 31 has a function to generate a PWM signal for driving a laser based on image data. When receiving the finally generated image data from the smoothing processing unit 30, the PWM signal conversion unit 31 generates the PWM signal for driving the laser based on the received image data, and forms an image. In general, in the multi-level PWM, a position control signal to control the reference of printing is also simultaneously generated based on the inputted image data.

For example, as shown in FIG. 3 described later, in the case where a pixel of a halftone is printed, the PWM signal conversion unit 31 performs the multi-level PWM, and also generates the position control signal to control the left, right, or (center) position reference with respect to the start position. In general, when there are the left and right position control signals, the image can be formed, and in the case where it is desired to control the position at higher precision, the center signal is also used.

When the printer engine 11 which is later stage of the printer controller 10 receives the position control signal, the printer engine 11 determines the print start position based on the received position control signal. That is, the PWM signal conversion unit 31 transmits the generated position control signal to the printer engine 11, and controls the start position of printing performed by the printer engine 11.

Incidentally, there is also a case where the printer controller 10 does not include the color conversion unit 23. Specifically, this is the case where the printer 5 is a monochrome printer.

The printer engine 11 has a function to convert the bitmap image data transmitted from the printer controller 10 into a drive signal, a function to transport a sheet on which an image as a print object is to be printed, and a function to perform drive control of a laser, and is a device to print the image as the print object on the sheet.

For example, a document, a graphic, a photograph or the like created and edited by the PC 4 or the like is converted into the PDL language or the like by the printer driver 6, and is subjected to the RIP processing by the printer controller 10, the page description language such as the PDL language is developed into a bitmap, and the color conversion and halftone processing are performed. The image data transmitted from the printer controller 10 to the printer engine 11 has one pixel of 1 bit to 8 bits for one color, and the image data of tone reproduction performance according to the printing performance of the output equipment is outputted. The printer engine 11 converts the image data transmitted from the printer controller 10 into the drive signal and forms the image, and prints the formed image, the image as the print object, on the sheet.

The image quality maintaining control device 12 includes a halftone parameter control unit 36 having a halftone parameter changing function in addition to the related art image quality maintaining control function. Besides, in order to provide a stable output image to a user, the image quality maintaining control device 12 has a correction function of the printer engine 11, and can stabilize the variation in the inside of the printer engine 11 by using the correction function. That is, the image quality maintaining control device 12 has a function to maintain and control an image quality by causing the printer controller 10 and the printer engine 11 to operate together.

As parameters (adjustment items) relating to the image quality maintenance which are adjusted when the image quality is maintained and controlled in the related art, for example, in addition to analog adjustments such as a T/C adjustment (toner concentration adjustment) of a developer, an adjustment of various potentials of a process, and an adjustment of laser power, there are known digital adjustments such as a TRC (tone reproduction curve) correction to stabilize the tone characteristic of a halftone of an image. The adjustment items relating to the image quality maintenance are information acquired from various sensors of the sensor device 18 or are calculated based on the acquired information. In the image quality maintaining control device 12, the related art image quality maintaining control method and the change of the halftone parameter can be performed together, and a more stable high-quality image is realized.

In general, the image quality maintaining control method of electrophotography is realized by a combination of two methods of open control and feedback control.

The open control is a method in which setting is previously performed in a sense, and in view of the printer engine characteristic to the life end, the developer concentration T/C, charging, development bias, and laser power are set according to the print number count value and the environmental sensor.

On the other hand, in the feedback control, in order to correct the tone characteristic of the printer engine 11 at higher precision, for example, a toner image is formed on a photoconductive body, the density value thereof is read by a density sensor, and for example, the density of a solid area is adjusted by the charging and development bias. Thereafter, in order to match the halftone to the target characteristic, based on the intermediate density value read by the density sensor, it is reflected on the output value of the laser power or the TRC table (for example, reflected on the CD/TF unit of FIG. 2), and the image quality maintenance is realized.

FIG. 3 relates to the image quality maintenance of the image forming apparatus 1, is a view for explaining the outline for matching the tone characteristic to the target by the image quality maintaining control, and is a view illustrating a relation between the density (vertical axis) and the tone (horizontal axis). Here, reference numerals 51, 52 and 53 denote curves representing target characteristics, 51 denotes the curve (Target-maximum curve) representing the maximum value of the target characteristic, 52 denotes the curve (Target-minimum curve) representing the minimum value of the target characteristic, 53 denotes the curve (Target-center curve) representing an intermediate value (ideal target characteristic) of the target characteristic, 54 denotes a reference point as a reference used when the tone characteristic is matched to the target, and 55 denotes a characteristic curve representing a relation between the tone obtained by an interpolation processing and the density.

With respect to the image quality maintenance of the image forming apparatus 1, since it is very important that the image quality maintaining control is executed at high speed and the consumption of toner is reduced, it is desirable that the image quality maintenance is realized by a smaller number of patches. The example shown in FIG. 3 is the example of a method of realizing the image quality maintenance by patches of two points of a solid part and a halftone part per one color.

The tone—density characteristic at the initial time (for example, just after the completion of a product) is generally in an ideal state represented by the characteristic curve 53. When the deterioration of the photoconductive body, the deterioration of a developer, the wear-out of a mechanism and the likes are caused by the influence of aging or the like, the target characteristic deviates from the ideal range. For example, in the case where the present characteristic is represented by the characteristic curve 55, in order to match the density of the reference point 54 of a halftone (for example, a range at about 100 in the case where the tone is expressed by 0 to 255) to the ideal characteristic curve 53, for example, the adjustment of lowering the output value of the laser power is performed. Besides, by this adjustment, in the case where the nonlinearity of the tone—density characteristic is weakened, the CD/TF unit 27 executes the characteristic conversion processing necessary for obtaining a preferable nonlinear characteristic.

In the image quality maintaining control by the adjustment which is performed in the related art, although a macroscopic tone characteristic can be almost matched to the target characteristic, when the correction precision is pursued, due to a difference between machines and an individual difference between materials, for example, various sensors with high precision are required, or a high power laser is required, and accordingly, an increase in manufacturing cost is caused. Thus, although it is very difficult to balance the correction precision with the manufacturing cost, this is very important.

On the other hand, when a microscopic area is seen, an electrophotographic apparatus has such a problem that as compared with the initial characteristic of a machine, deterioration of a photoconductive body, deterioration of a developer, wear-out of a mechanism and the like occur by the influence of aging or the like, the toner becomes liable to be scattered and the reproduction becomes unstable, or mechanical jitter increases.

In the electrophotographic apparatus, for example, in the state where color shift or jitter is more liable to occur than at the initial time, even if the related art image quality maintaining control processing is executed, in-plane stability is reduced, and the image quality can remarkably deteriorate.

Then, in consideration of the above circumstances, so as to realize stable reproduction of an image against such mechanical variations, the image forming apparatus 1 is constructed to include the image quality maintaining control device 12 having a function to change a halftone parameter (for example, screen data of halftone processing such as the number of screen lines, dot interval, size, angle and shape) at the time of execution of the image quality maintenance. That is, the image forming apparatus 1 is constructed to include the image quality maintaining control device 12 provided with the halftone parameter control unit 36, and consequently, high quality image can be outputted more stably than the related art.

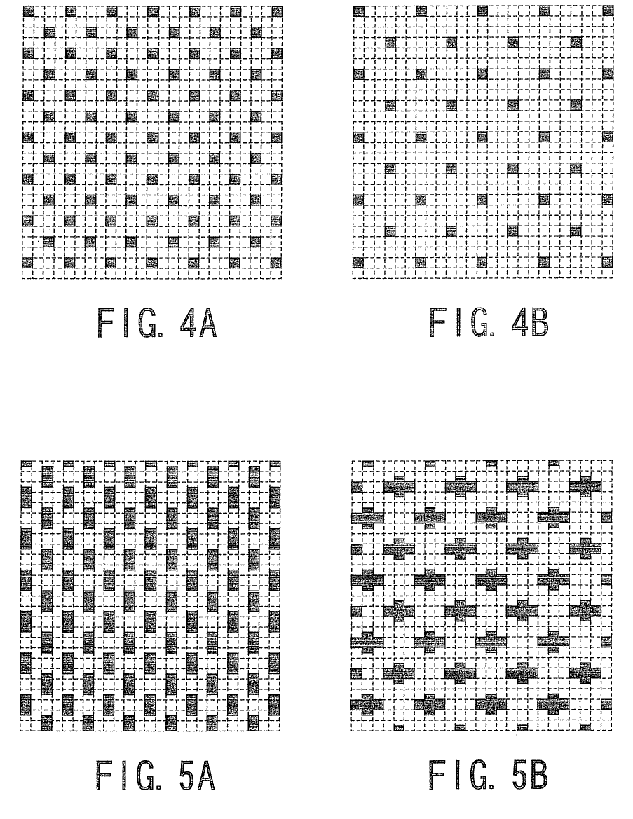

An example of a method of correcting the deterioration of image quality caused with use or with the lapse of time, which is carried out in the invention, will be described with reference to FIGS. 4A, 5A and 6A (pale pattern) and FIGS. 4B, 5B and 6B (dense pattern).

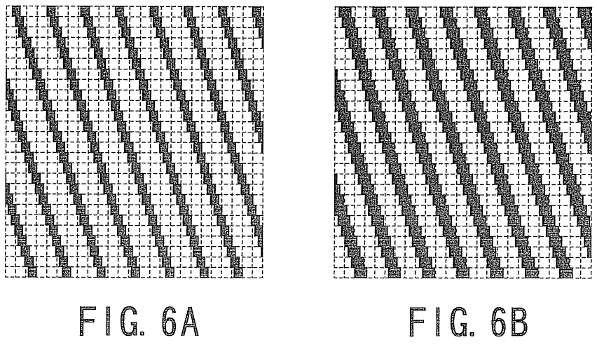

FIGS. 4A, 5A and 6A are views illustrating output patterns after halftone processing of a certain color (for example, black) out of four colors of CMYK and are at the initial time, and FIGS. 4B, 5B and 6B are respectively output pattern views corresponding to FIGS. 4A, 5A and 6A and are views at the time of execution of image quality maintaining control (after halftone parameter adjustment). Hereinafter, the adjustment methods of the halftone parameters shown in FIG. 4 (FIGS. 4A and 4B), FIG. 5 (FIGS. 5A and 5B) and FIG. 6 (FIGS. 6A and 6B) will be described in sequence.

FIGS. 4A and 4B are views illustrating an example of a method of adjusting the halftone parameter by adjustment of the number of screen lines. First, at the initial time, since the characteristic of the printer engine 11 is very stable, as shown in FIG. 4A as an example, setting is made such that a dot image having no directional dependency and having excellent taste is realized by initial setting (default), and the image is constructed by the halftone processing in which the number of screen lines is high.

Thereafter, when the use is continued, and in the case where the image quality maintaining control becomes necessary, at the time of execution of the image quality maintaining control, for example, in the following conditions:
1. when a specified number of output sheets are counted or specified print pixels are counted (characteristic of the life is considered);
2. when the outputs of various sensors (temperature and humidity sensor, density sensor, etc.) of the sensor device 18 and a condition derived based on the outputs deviate from a specified range (for example, the range of the upper limit and lower limit shown in FIG. 3);
3. when a consumable part is replaced;
4. when a specific sheet is detected; and
5. when a service man or a user receives a forcible switching request;
   in the case where at least one of the conditions is satisfied, the processing of changing the halftone parameter is executed. Specifically, as shown in FIG. 4B, the screen data of the halftone processing is switched so that the image is constructed by the halftone processing in which the number of screen lines is smaller than that at the initial time.

As shown in FIG. 4A and FIG. 4B, although the reduction in the number of screen lines works in the direction in which the image quality is reduced in resolution, the method has a very large effect in stable reproduction of an image. Incidentally, when the consumable part is replaced (case of the above 3) or when the specific sheet (for example, a paper having high smoothness) is detected (case of the above 4), since there is also a case where the print condition of a process or a mechanism is improved, in this case, reversely, the halftone processing in which the number of screen lines is high is performed, and both the resolution and the image stability can be improved. The same applies to examples shown in FIG. 5 and FIG. 6.

FIGS. 5A and 5B are views illustrating an example of a method of adjusting the halftone parameter by adjustment of a dot interval and size.

First, at the initial time, as shown in FIG. 5A, since the characteristic of the printer engine 11 is very stable, setting is made such that an image is constructed by a halftone processing in which the dot interval is fine and the size thereof is small. Thereafter, the use is continued, and in the case where the image quality maintaining control becomes necessary, similarly to the example shown in FIG. 4, when a specified condition is satisfied, the halftone parameter is switched. Specifically, as shown in FIG. 5B, the screen data of the halftone processing is switched so that the image is constructed by the halftone processing in which the dot interval is coarse and the size thereof is large as compared at the initial time.

FIGS. 6A and 6B are views illustrating an example of a method of adjusting the halftone parameter by adjustment of the shape and angle.

First, at the initial time, as shown in FIG. 6A, the shape as an example of the halftone parameter is switched to, for example, a line type. The feature that the line type screen (line tone screen) has high resistance to the jitter is used.

Here, in the case where the scanning direction of the laser is made 0° and the transport direction of the paper is made 90°, in general, the print precision is bad in the transport direction of the paper. Besides, when the screen data is made to have an angle close to 90°, the resistance to the jitter is high.

Then, in the example shown in FIG. 6B, the angle, together with the shape of the halftone parameter, is changed (for example, 45° is changed to 71°). As a result, in the image forming apparatus 1, the reproduction of the image more stable than the related art becomes possible. Incidentally, the angle and the shape as the example of the halftone parameter may be changed together or may be singly changed as long as the screen can be designed at the resolution.

Incidentally, the degree of freedom of design of the screen becomes advantageous geometrically when the resolution becomes high.

Besides, by this, the image quality maintaining control can be executed at high speed. However, when the image quality maintaining control is executed with different halftone design data, it is necessary to previously take a correlation between the pattern and the halftone parameter as the switching object, and by this, the correction with high precision can be performed.

Further, when the number of screen lines of the embodiment is also considered, in the case where the condition is such that the screen can be designed at the resolution, there is also a case where the halftone parameter control unit 36 adjusts the halftone parameters by cooperatively changing the halftone parameters including the number of screen lines, dot interval, size, angle, shape and the like, or there is also a case where the halftone parameters are adjusted by singly changing each of the halftone parameters.

Incidentally, in this embodiment, although the structure of the single color (for example, black) has been described, this may be performed individually or cooperatively according to the respective characteristics of the four colors of CMYK. However, in this case, it is necessary to pay attention so that a color moire does not occur. That is, it is important that the angle and the number of lines of CMYK are set.

In this embodiment, although the printer function has been mainly described, no limitation is made to this, and it is important to operate cooperatively with all the functions applied as another MFP such as a copier using print means. This can be easily realized by considering a path of the MFP.

Besides, at the time of execution of the image quality maintaining control, as the pattern recorded on the photoconductive body or the belt, the pattern in which the halftone parameter is switched may be used as it is, or another pattern may be used. This is because the MFP has plural functions, and there can occur a case where different halftone design data are used in respective functions.

The switching of the halftone parameter at the time of execution of the image quality maintaining control in this embodiment is not always performed once, and may be switched, for example, stepwise in view of the characteristic of the life.

According to the invention, the parameter switching of the halftone processing is performed cooperatively with the image quality maintaining control, so that macroscopically and microscopically stable images can be reproduced against the variation of the printer engine 11 due to the environmental variation by temperature/humidity, change of material characteristics, such as toner and developer, by aging, the wear-out of a mechanism and the like.

That is, the image forming apparatus 1 is constructed to include the image quality maintaining control device 12 having the function to change the halftone parameter such as the number of screen lines at the time of execution of the image quality maintaining control, and consequently, high-quality image can be outputted more stably than the related art. Besides, by the image forming method in which the halftone parameter control processing to change the halftone parameter is also executed when the image quality maintaining control processing of the printer of the electrophotographic system is executed, high-quality image can be outputted more stably than the related art.

Incidentally, the invention is not limited to just the respective embodiments, and the components may be modified and embodied at the practical phase within the scope not departing from the gist.

What is claimed is:

1. An image forming apparatus comprising:
an electrophotographic printer including a printer controller that performs an image processing on image data into which a page description language is developed and outputs the image data to a printer engine, and the printer engine to perform printing of an image based on the image data transmitted from the printer controller; and
an image quality maintaining control device configured to maintain image quality of the printer,
wherein the image quality maintaining control device includes a halftone parameter control unit configured to change a halftone parameter when an image quality maintaining control processing of the printer is executed.

2. The image forming apparatus according to claim 1, wherein the image quality maintaining control device executes, as the image quality maintaining control processing, at least one processing of a process potential adjustment, a laser power adjustment, a development density adjustment, and a tone correction by the image processing, and the halftone parameter control unit switches screen data of a halftone processing to change the halftone parameter.

3. The image forming apparatus according to claim 1, wherein the halftone parameter control unit changes the halftone parameter in a case where an output amount of the printer reaches a specified amount, and the output amount of the printer is at least one of the number of output sheets of the printer and a print pixel count of the printer.

4. The image forming apparatus according to claim 1, further comprising a sensor device having at least one sensor to acquire a physical quantity necessary for an operation and a control of the image forming apparatus,
wherein the halftone parameter control unit changes the halftone parameter in a case where the physical quantity acquired by the sensor device and a condition derived based on the physical quantity deviate from a specified range.

5. The image forming apparatus according to claim 1, wherein the halftone parameter control unit changes the halftone parameter in at least one of a case where a consumable part is replaced, a case where it is detected that a sheet of a print object is a specific sheet, and a case where a forcible change request is received.

6. The image forming apparatus according to claim 1, wherein the halftone parameter control unit changes the halftone parameter by switching screen data of a halftone processing, and the screen data is one of the number of screen lines, dot interval, size, angle and shape.

7. The image forming apparatus according to claim 1, wherein the halftone parameter control unit switches screen data of a halftone processing stepwise to change the halftone parameter.

8. An image forming method, comprising
executing a halftone parameter control processing of changing a halftone parameter when an image quality maintaining control processing of an electrophotographic printer is executed.

9. The image forming method according to claim 8, wherein the image quality maintaining control processing includes at least one processing of a process potential adjustment, a laser power adjustment, a development density adjustment, and a tone correction by an image processing, and the halftone parameter control processing is a processing of switching screen data of a halftone processing.

10. The image forming method according to claim 8, wherein the halftone parameter control processing is a processing of changing the halftone parameter in a case where an output amount of the printer reaches a specified amount, and the output amount of the printer is at least one of the number of output sheets of the printer and a print pixel count of the printer.

11. The image forming method according to claim 8, wherein the halftone parameter control processing is a processing of changing the halftone parameter in one of a case where a physical quantity acquired by a sensor device and a condition derived based on the physical quantity deviate from a specified range, a case where a consumable part is replaced, a case where it is detected that a sheet of a print object is a specific sheet, and a case where a forcible change request is received.

12. The image forming method according to claim 8, wherein the halftone parameter control processing is a processing of changing the halftone parameter by switching screen data of a halftone processing, and the screen data is one of the number of screen lines, dot interval, size, angle and shape.

13. The image forming method according to claim 8, wherein the halftone parameter control processing is a processing of changing the halftone parameter by switching screen data of a halftone processing in stages.
